(19) United States
(12) Patent Application Publication
(10) Pub. No.: US 2021/0295632 A1
(43) Pub. Date: Sep. 23, 2021

(54) COIN HANDLING APPARATUS

(71) Applicant: Glory Ltd., Himeji-shi (JP)

(72) Inventors: Fumio KIBIHARA, Hyogo (JP); Hidekazu TANAKA, Hyogo (JP); Mitsuo TANAKA, Hyogo (JP)

(73) Assignee: Glory Ltd., Himeji-shi (JP)

(21) Appl. No.: 17/207,769

(22) Filed: Mar. 22, 2021

(30) Foreign Application Priority Data
Mar. 23, 2020 (JP) 2020-050814

(51) Int. Cl. G07D 9/00; G07D 1/06; G07D 11/40; G07G 1/10

(52) U.S. Cl. CPC G07D 9/00; G07D 1/06; G07D 2201/00; G07G 1/10; G07D 11/40

(57) ABSTRACT

Provided is a coin handling apparatus including: a drawer attachment unit to which a drawer is attached; a first cassette attachment unit to which a coin transport cassette including an opening to be opened when the coin transport cassette is attached to a specific apparatus and giving or receiving a coin to or from the specific apparatus via the opening is attached; a storage unit storing the coin and feeding out the stored coin; and a first transport unit transporting the coin fed out of the storage unit to the drawer attached to the drawer attachment unit or the coin transport cassette attached to the first cassette attachment unit. The first cassette attachment unit is provided at a position different from a position of the drawer attachment unit. The coin transport cassette is attachable to the first cassette attachment unit when the drawer is attached to the drawer attachment unit.

### CROSS REFERENCE TO RELATED APPLICATION

The present application is based on and claims priority to Japanese Patent Application No. 2020-050814 filed on Mar. 23, 2020. The entire disclosure of the above-identified application, including the specification, drawings and claims is incorporated herein by reference and its entirety.

### TECHNICAL FIELD

The present disclosure relates to a coin handling apparatus.

### BACKGROUND

In the related art, as a cash management system installed in a store, there is known a system comprising: a first cash handling apparatus that performs settlement processing by depositing and dispensing cash; and a second cash handling apparatus that dispenses cash that is loaded to the first cash handling apparatus, and that deposits cash collected from the first cash handling apparatus (see, for example, Patent Literature (hereinafter, referred to as “PTL”) 1). The first cash handling apparatus is disposed in a register counter in a store, and the second cash handling apparatus is disposed in a backyard in the store. The first cash handling apparatus includes a type in which cash is manually deposited or dispensed upon settlement, and a type in which cash is automatically deposited or dispensed upon settlement. In such a cash management system, a drawer or a cash transport cassette is used for cash transport between the first cash handling apparatus and the second cash handling apparatus.

### CITATION LIST

### Patent Literature

PTL 1
Japanese Patent No. 5902667

### SUMMARY

A coin handling apparatus of the present disclosure includes: a drawer attachment unit to which a drawer for a register is attached; a first cassette attachment unit to which a coin transport cassette is attached; a storage unit that stores a coin, and feeds out the coin that has been stored; and a first transport unit that transports the coin fed out of the storage unit to the drawer attached to the drawer attachment unit or the coin transport cassette attached to the first cassette attachment unit. The coin transport cassette gives or receives the coin to or from a specific apparatus via an opening that is opened when the coin transport cassette is attached to the specific apparatus. The first cassette attachment unit is provided at a position different from a position of the drawer attachment unit and configured to allow the coin transport cassette to be attached to the first cassette attachment unit when the drawer is attached to the drawer attachment unit.

### BRIEF DESCRIPTION OF DRAWINGS

FIG. 1 is a block diagram illustrating a schematic configuration of a money handling system according to an embodiment of the present disclosure;

FIG. 2A is a top view illustrating a schematic configuration of a coin transport cassette according to the embodiment of the present disclosure;

FIG. 2B is a cross-sectional view taken along IIB-IIB of FIG. 2A according to the embodiment of the present disclosure;

FIG. 3 is a perspective view of an external appearance of the coin transport cassette according to the embodiment of the present disclosure;

FIG. 4 is a perspective view of the external appearance of the coin transport cassette according to the embodiment of the present disclosure when viewed from an angle different from that in FIG. 3;

FIG. 5 is a perspective view of an external appearance of a first coin handling apparatus according to the embodiment of the present disclosure;

FIG. 6 is a schematic diagram illustrating an internal configuration of the first coin handling apparatus according to the embodiment of the present disclosure;

FIG. 7 is a perspective view of an external appearance of a second coin handling apparatus according to the embodiment of the present disclosure;

FIG. 8A is a perspective view illustrating a state in which a cover of the second coin handling apparatus is opened according to the embodiment of the present disclosure;

FIG. 8B is a perspective view illustrating a state in which the coin transport cassette is attached to the second coin handling apparatus according to the embodiment of the present disclosure;

FIG. 9 is a perspective view illustrating a configuration of the cover and a tray according to the embodiment of the present disclosure;

FIG. 10A is a perspective view illustrating a state in which the tray covers an exposure port of the cover according to the embodiment of the present disclosure;

FIG. 10B is a side view illustrating a position of a first turning pin of the tray in a first pin guide groove of the cover in the state of FIG. 10A according to the embodiment of the present disclosure;

FIG. 11A is a perspective view illustrating a state in which the tray does not cover the exposure port of the cover according to the embodiment of the present disclosure;

FIG. 11B is a side view illustrating a position of the first turning pin of the tray in the first pin guide groove of the cover in the state of FIG. 11A according to the embodiment of the present disclosure;

FIG. 12A is a perspective view illustrating how the coin transport cassette is attached to the second coin handling apparatus according to the embodiment of the present disclosure;

FIG. 12B is a perspective view illustrating how a drawer is attached to the second coin handling apparatus according to the embodiment of the present disclosure;

FIG. 13A is a schematic diagram illustrating an internal configuration of the second coin handling apparatus according to the embodiment of the present disclosure when viewed from a right side, illustrating a state when coins collected by the coin transport cassette are counted;

FIG. 13B is a schematic diagram illustrating the internal configuration of the second coin handling apparatus in the state of FIG. 13A according to the embodiment of the present disclosure when viewed from a front side;

FIG. 14A is a diagram for describing a width direction regulating member provided on an upper-side transport path according to the embodiment of the present disclosure;

FIG. 14B is a diagram for describing the width direction regulating member provided on the upper-side transport path according to the embodiment of the present disclosure;

FIG. 15A is a schematic diagram illustrating the internal configuration of the second coin handling apparatus according to the embodiment of the present disclosure when viewed from the right side, illustrating a state when the drawer is replenished with a coin;

FIG. 15B is a schematic diagram illustrating the internal configuration of the second coin handling apparatus in the state of FIG. 15A according to the embodiment of the present disclosure when viewed from the front side;

FIG. 16A is a schematic diagram illustrating the internal configuration of the second coin handling apparatus according to the embodiment of the present disclosure when viewed from the right side, illustrating a state when the coin transport cassette is replenished with a coin; and

FIG. 16B is a schematic diagram illustrating the internal configuration of the second coin handling apparatus in the state of FIG. 16A according to the embodiment of the present disclosure when viewed from the front side.

### DETAILED DESCRIPTION

In a technique as in PTL 1, however, the drawer or the cash transport cassette cannot be attached to the second cash handling apparatus at the same time. For this reason, in a case where change is prepared for both the drawer and the cash transport cassette, a reduction in time for preparing change may not be achieved since, for example, after change is inserted into the drawer, it is necessary to detach the drawer from the second cash handling apparatus, to attach the cash transport cassette to the second cash handling apparatus, and then to insert change into the cash transport cassette.

An object of the present disclosure is to provide a coin handling apparatus capable of reducing time for storing a coin in a drawer and a coin transport cassette.

According to the coin handling apparatus of the present disclosure, it is possible to reduce time for storing a coin in the drawer and the coin transport cassette.

[Embodiment]

Hereinafter, an embodiment of the present disclosure will be described with reference to the accompanying drawings.

<Configuration of Money Handling System>

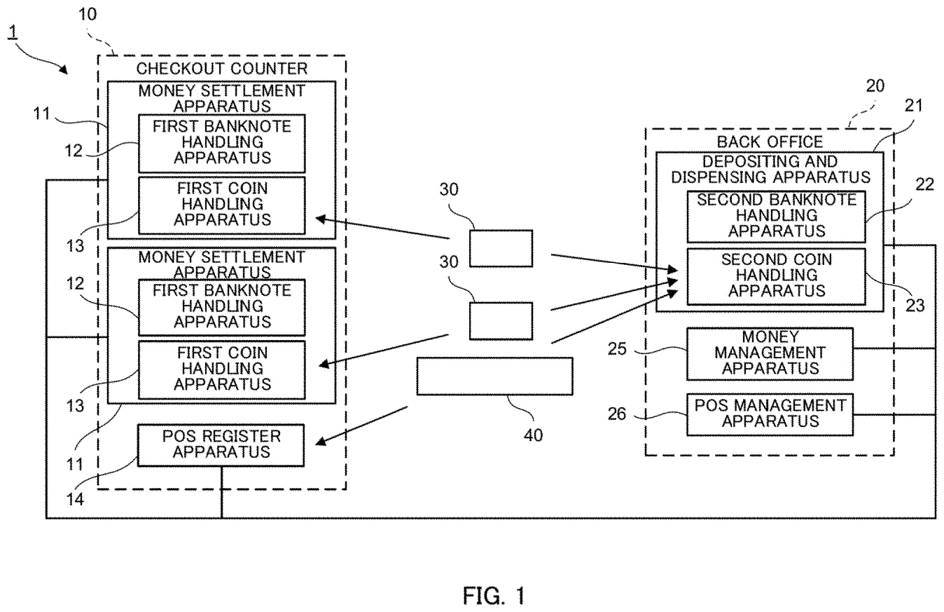

First, a configuration of a money handling system will be described. In the present embodiment, a front office of a store refers to an area where a money settlement apparatus whereby a customer settles a commercial product is installed. A back office of a store refers to an area where an apparatus that manages banknotes and coins that are handled by a money settlement apparatus is installed. Note that, in the present embodiment, banknotes and coins may be referred to collectively as money. FIG. 1 is a block diagram illustrating a schematic configuration of a money handling system according to an embodiment of the present disclosure.

A money handling system 1 illustrated in FIG. 1 is a system for distribution and is installed in a store. The money handling system 1 comprises two money settlement apparatuses 11, one POS register apparatus 14, a depositing and dispensing apparatus 21, a money management apparatus 25, a POS management apparatus 26, and coin transport cassettes 30. Note that, the money handling system 1 may comprise one or not less than three money settlement apparatuses 11 and/or may comprise not less than two POS register apparatuses 14.

The money settlement apparatuses 11 are installed in a checkout counter 10 that is an example of a front office of a store. The money settlement apparatus 11 is operated by a clerk or a customer himself/herself, and is used in settlement processing between a clerk and a customer. The money settlement apparatus 11 deposits payment paid by a customer or dispenses change that is paid to a customer. The money settlement apparatus 11 is communicably connected to a POS register (not illustrated) that is operated by a clerk or to a self-checkout register (not illustrated) that is operated by a customer. Note that, the money settlement apparatus 11 may be integrally formed with the POS register or the self-checkout register.

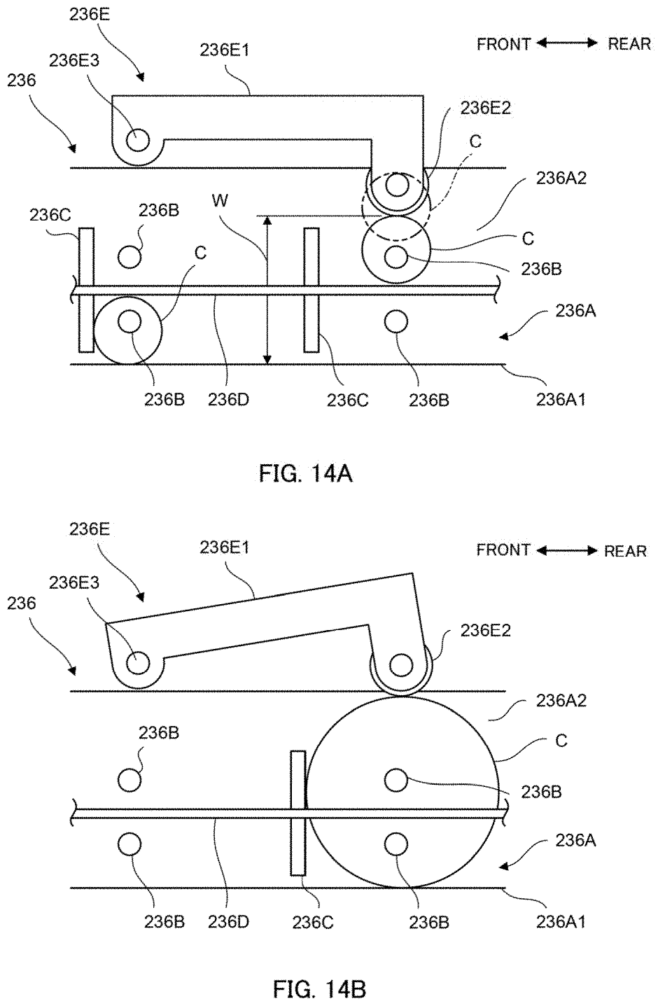

The money settlement apparatus 11 comprises: a first banknote handling apparatus 12 that handles a banknote; and a first coin handling apparatus 13 that handles a coin C (see FIG. 14A). Details of the first coin handling apparatus 13 will be described later. Note that, at least one of the two money settlement apparatuses 11 may be an apparatus that performs only depositing and dispensing processing of the coin C.

The POS register apparatus 14 is installed in the checkout counter 10. A clerk manually deposits or dispenses money to or from a drawer 40, thereby settlement processing of the POS register apparatus 14 is performed.

The depositing and dispensing apparatus 21, the money management apparatus 25, and the POS management apparatus 26 are installed in a back office 20 of the store. The depositing and dispensing apparatus 21 is communicably connected to each of the money settlement apparatuses 11 and to the POS register apparatus 14. The depositing and dispensing apparatus 21 dispenses a change fund for being loaded to the money settlement apparatus 11 and the POS register apparatus 14, or deposits proceeds from sales collected from the money settlement apparatus 11 and the POS register apparatus 14. The depositing and dispensing apparatus 21 comprises: a second banknote handling apparatus 22 that handles a banknote; and a second coin handling apparatus 23 that handles the coin C. Details of the second coin handling apparatus 23 will be described later.

The money management apparatus 25 is communicably connected to each of the money settlement apparatuses 11, to the POS register apparatus 14, and to the depositing and dispensing apparatus 21 via a local area network (LAN) or the like. The money management apparatus 25 manages money stored in each of the money settlement apparatuses 11, in the POS register apparatus 14, and in the depositing and dispensing apparatus 21. For example, the money management apparatus 25 manages money subjected to settlement processing in each of the money settlement apparatuses 11 and in the POS register apparatus 14, respectively, and manages money given or received between the money settlement apparatus 11 and the depositing and dispensing apparatus 21, and money given or received between the POS register apparatus 14 and the depositing and dispensing apparatus 21. Further, the money management apparatus 25 may monitor whether the coin transport cassette 30 is attached to the money settlement apparatus 11 or the depositing and dispensing apparatus 21. The money management apparatus 25 may monitor whether the drawer 40 is attached to the POS register apparatus 14 or the depositing and dispensing apparatus 21. The POS management apparatus 26 manages a flow of a commercial product. Note that, at least two of the POS register apparatus 14, the money management apparatus 25, and the POS management apparatus 26 may be integrally formed.

The coin transport cassette 30 is configured to be attachable to and detachable from the first coin handling apparatus 13 of the money settlement apparatus 11, and to be attachable to and detachable from the second coin handling apparatus 23 of the depositing and dispensing apparatus 21. When the coin transport cassette 30 is attached to the first coin handling apparatus 13, the coin transport cassette 30 is configured to be capable of giving or receiving the coin C between the coin transport cassette 30 and the first coin handling apparatus 13. When the coin transport cassette 30 is attached to the second coin handling apparatus 23, the coin transport cassette 30 is configured to be capable of giving or receiving the coin C between the coin transport cassette 30 and the second coin handling apparatus 23. The first coin handling apparatus 13 and the second coin handling apparatus 23 are examples of a specific apparatus. On the other hand, the coin transport cassette 30 is configured such that the coin C therein cannot be taken out when the coin transport cassette 30 is detached from the first coin handling apparatus 13 and the second coin handling apparatus 23. A clerk uses the coin transport cassette 30 to transport the coin C between the first coin handling apparatus 13 and the second coin handling apparatus 23. For example, when a change fund is loaded or when proceeds from sales are collected, a clerk uses the coin transport cassette 30 to transport the coin C between the first coin handling apparatus 13 and the second coin handling apparatus 23. The clerk cannot touch the coin C in the coin transport cassette 30 when transporting the coin C. For this reason, the coin C can be transported in a safe state in terms of security. Note that, it may also be configured such that only a person having the authority, such as a manager of a store, is allowed to open the coin transport cassette 30.

The drawer 40 is configured to be attachable to and detachable from the POS register apparatus 14, and to be attachable to and detachable from the second coin handling apparatus 23 of the depositing and dispensing apparatus 21. For example, when a change fund is loaded or when proceeds from sales are collected, a clerk uses the drawer 40 to transport the coin C between the POS register apparatus 14 and the second coin handling apparatus 23.

<Configuration of Coin Transport Cassette>

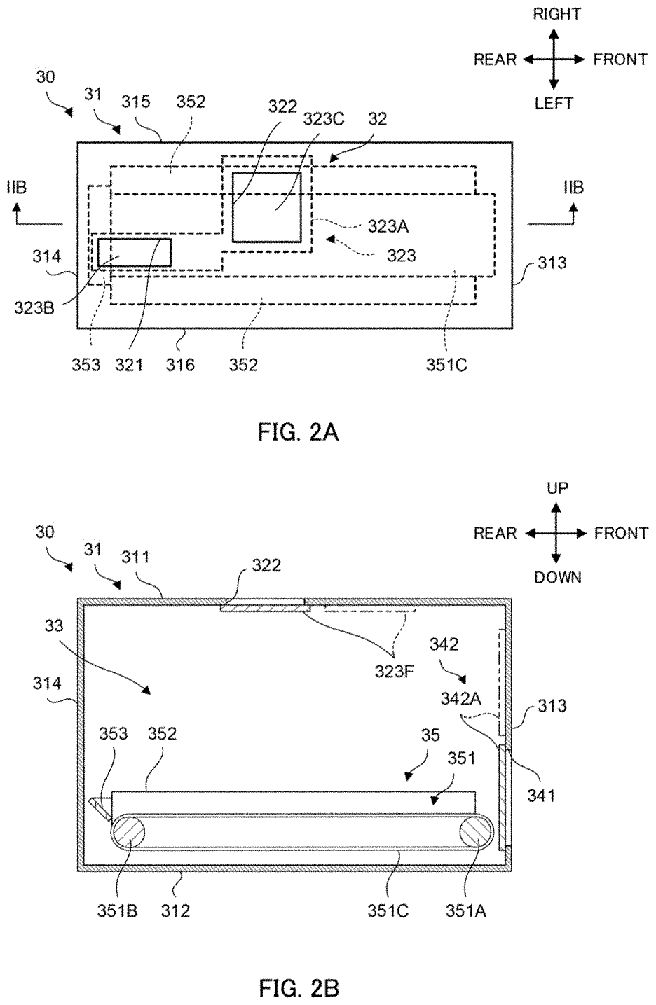

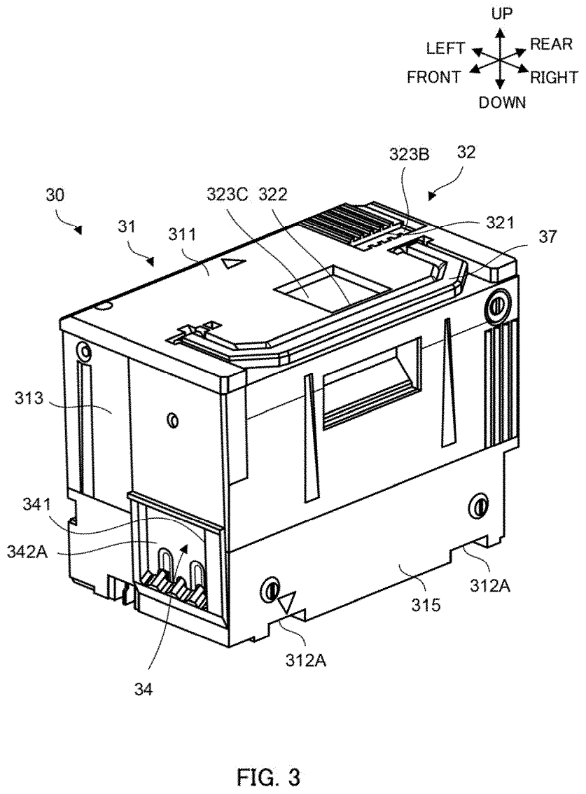

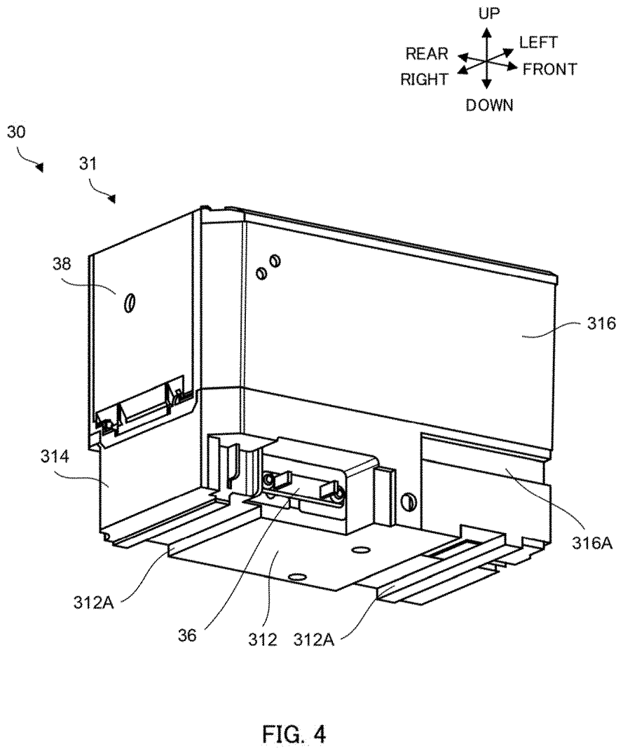

Next, a configuration of the coin transport cassette 30 will be described. FIG. 2A is a top view illustrating a schematic configuration of the coin transport cassette. FIG. 2B is a cross-sectional view taken along IIB-IIB of FIG. 2A. FIG. 3 is a perspective view of an external appearance of the coin transport cassette. FIG. 4 is a perspective view of the external appearance of the coin transport cassette when viewed from an angle different from that in FIG. 3. Note that, the arrangement of each configuration of the coin transport cassette 30 or the like may be described using the directions indicated in FIG. 2A, FIG. 2B, FIG. 3 and FIG. 4.

As illustrated in FIG. 2A, FIG. 2B, FIG. 3 and FIG. 4, the coin transport cassette 30 comprises a housing 31, a reception unit 32, a storage unit 33, a discharge unit 34, a feeding unit 35, a connector 36, a holding portion 37, and an opening and closing door 38.

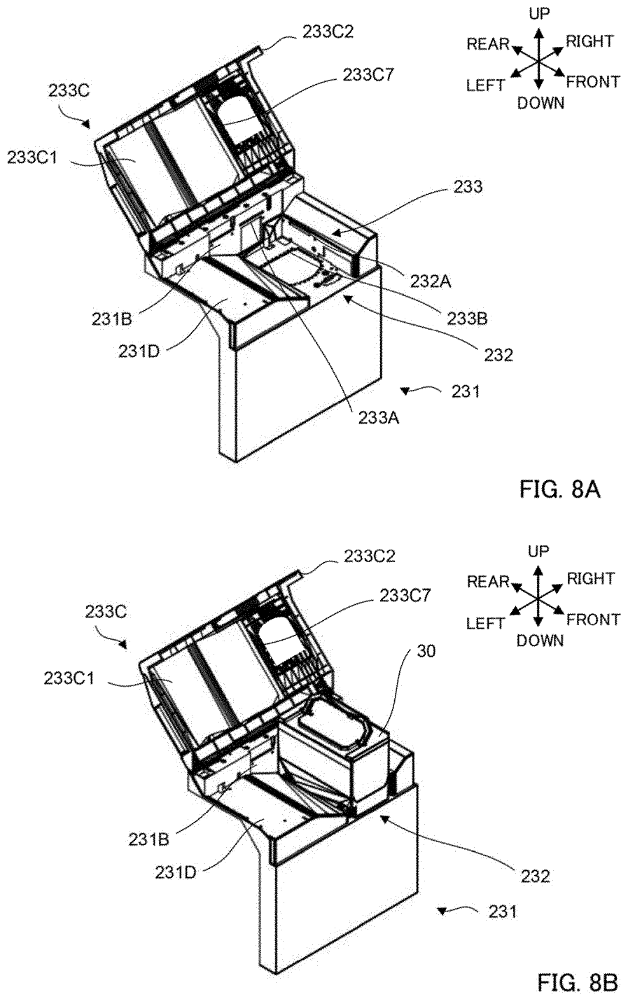

The housing 31 comprises an upper surface portion 311, a bottom surface portion 312, a front surface portion 313, a rear surface portion 314, a right surface portion 315, and a left surface portion 316. As illustrated in FIG. 3 and FIG. 4, the bottom surface portion 312 is provided with first guide grooves 312A extending rightward and leftward. The first guide grooves 312A are provided in a front portion and a rear portion of the bottom surface portion 312, respectively. The first guide grooves 312A are configured such that, when the coin transport cassette 30 is attached to the first coin handling apparatus 13, the coin transport cassette 30 is guided in a state in which the left surface portion 316 is located at the front in the attachment direction by fitting guide rails (not illustrated) provided on the first coin handling apparatus 13 into the first guide grooves 312A. As illustrated in FIG. 4, a second guide groove 316A extending frontward and rearward is provided in a front portion of the left surface portion 316. The second guide groove 316A is configured such that, when the coin transport cassette 30 is attached to the second coin handling apparatus 23, the coin transport cassette 30 is guided in a state in which the front surface portion 313 is located at the front in the attachment direction by fitting a guide rail 232A (see FIG. 8A) provided on the second coin handling apparatus 23 into the second guide groove 316A. That is, the coin transport cassette 30 is configured such that the attachment direction when the coin transport cassette 30 is attached to the first coin handling apparatus 13 differs by 90° from the attachment direction when the coin transport cassette 30 is attached to the second coin handling apparatus 23. Note that, the angle formed by the direction when the coin transport cassette 30 is attached to the first coin handling apparatus 13 and the direction when the coin transport cassette 30 is attached to the second coin handling apparatus 23 may not be 90° and may be 0° (the direction when the coin transport cassette 30 is attached to the first coin handling apparatus 13 and the direction when the coin transport cassette 30 is attached to the second coin handling apparatus 23 are the same).

The reception unit 32 receives the coin C from the first coin handling apparatus 13 or the second coin handling apparatus 23. As illustrated in FIG. 2A, FIG. 2B and FIG. 3, the reception unit 32 comprises a first reception port 321, a second reception port 322, and a reception port opening and closing unit 323.

The first reception port 321 is provided in a rear portion of the upper surface portion 311. The first reception port 321 is formed in a rectangle whose long side direction is parallel to the front-rear direction of the housing 31. The first reception port 321 is configured to be capable of receiving the coin C from the first coin handling apparatus 13. Note that, the shape of the first reception port 321 is not limited to a rectangle, and may also be any other shape.

The second reception port 322 is provided near the center of the upper surface portion 311. The second reception port 322 is formed in a quadrangle whose sides orthogonal to each other have a substantially equal length. The second reception port 322 has an opening area larger than the opening area of the first reception port 321. The second reception port 322 is configured to be capable of receiving the coin C from the second coin handling apparatus 23. Note that, the shape of the second reception port 322 is not limited to a quadrangle, and may also be any other shape.

The reception port opening and closing unit 323 opens and closes the first reception port 321 and the second reception port 322. The reception port opening and closing unit 323 comprises a reception port blocking member 323A, and a reception port opening and closing driving unit (not illustrated). The reception port blocking member 323A is formed in a plate shape. A part of the reception port blocking member 323A forms a first blocking unit 323B that blocks the first reception port 321. Another part of the reception port blocking member 323A forms a second blocking unit 323C that blocks the second reception port 322. The reception port opening and closing driving unit comprises an opening and closing motor, and an opening and closing mechanism. The opening and closing motor is driven by control of the first coin handling apparatus 13 or the second coin handling apparatus 23. The opening and closing mechanism moves the reception port blocking member 323A frontward and rearward. The opening and closing mechanism is controlled by the driving of the opening and closing motor to move the reception port blocking member 323A frontward and rearward, whereby both the first reception port 321 and the second reception port 322 can be opened or closed simultaneously. Note that, the first reception port 321 and the second reception port 322 may be opened or closed individually.

As illustrated in FIG. 2B, the storage unit 33 is an inner space of the housing 31. The storage unit 33 stores the coin C received at the reception unit 32.

The discharge unit 34 discharges the coin C stored in the storage unit 33. As illustrated in FIG. 2B and FIG. 3, the discharge unit 34 comprises a discharge port 341, and a discharge port opening and closing unit 342.

The discharge port 341 is an example of an opening, and is provided in a lower portion of the front surface portion 313.

The discharge port opening and closing unit 342 opens and closes the discharge port 341. The discharge port opening and closing unit 342 comprises a discharge port blocking member 342A, an opening and closing motor (not illustrated), and an opening and closing mechanism (not illustrated). The discharge port blocking member 342A is formed in a plate shape. The opening and closing motor is driven by control of the first coin handling apparatus 13 or the second coin handling apparatus 23. The opening and closing mechanism moves the discharge port blocking member 342A upward and downward. The opening and closing mechanism is controlled by the driving of the opening and closing motor to move the discharge port blocking member 342A upward and downward, whereby the discharge port 341 can be opened and closed.

The feeding unit 35 feeds out the coin C stored in the storage unit 33 such that the coin C is discharged from the discharge unit 34. As illustrated in FIG. 2A and FIG. 2B, the feeding unit 35 comprises a transport mechanism 351, side wall portions 352, and a rear wall portion 353.

The transport mechanism 351 is an example of a cassette transport unit that transports the coin C in a horizontal direction. Note that, the horizontal direction mentioned here does not mean the horizontal direction in a strict sense, but means a state in which a horizontal-direction component of the transport direction is larger than a vertical-direction component thereof. However, the transport direction may also be the horizontal direction in a strict sense. The transport mechanism 351 comprises a transport motor (not illustrated), a driving pulley 351A, a driven pulley 351B, and a transport belt 351C. The transport motor is driven by control of the first coin handling apparatus 13 or the second coin handling apparatus 23. In a front and lower portion of the coin transport cassette 30, the driving pulley 351A is provided on a rotating shaft of the transport motor so as to extend rightward and leftward. In a rear and lower portion of the coin transport cassette 30, the driven pulley 351B is supported by a bearing (not illustrated) so as to extend rightward and leftward. The transport belt 351C is wound around the driving pulley 351A and the driven pulley 351B. The coin C received through the reception unit 32 is placed on the transport belt 351C. That is, the transport belt 351C forms a bottom portion of the storage unit 33.

The side wall portions 352 are provided on both sides of the transport belt 351C in the width direction, respectively. The side wall portions 352 are inclined so as to gradually approach each other downward such that the coin C that has fallen from the reception unit 32 can be guided onto the transport belt 351C.

The rear wall portion 353 is provided rearward from the transport belt 351C. The rear wall portion 353 is inclined so as to gradually approach the rear surface portion 314 upward such that the coin C that has fallen from the reception unit 32 can be guided onto the transport belt 351C.

As illustrated in FIG. 4, the connector 36 is provided so as to be exposed to the outside from a rear and lower portion of the left surface portion 316 of the housing 31. The connector 36 is connected to a connector (not illustrated) of the first coin handling apparatus 13 when the coin transport cassette 30 is attached to the first coin handling apparatus 13. The connector 36 is connected to a connector (not illustrated) of the second coin handling apparatus 23 when the coin transport cassette 30 is attached to the second coin handling apparatus 23. When the connector 36 is connected to the connector of the first coin handling apparatus 13 or the second coin handling apparatus 23, power is supplied to the opening and closing motor of the reception port opening and closing unit 323, the opening and closing motor and the transport motor of the discharge unit 34, and/or the like via the connector 36 such that the opening and closing motor of the reception port opening and closing unit 323, the opening and closing motor and the transport motor of the discharge unit 34, and/or the like operate. When the connector 36 is connected to the connector of the first coin handling apparatus 13 or the second coin handling apparatus 23, the coin transport cassette 30 can be controlled by the first coin handling apparatus 13 or the second coin handling apparatus 23 via the connector 36.

The holding portion 37 is configured such that a clerk can hold the coin transport cassette 30 when the clerk transports the coin transport cassette 30.

The opening and closing door 38 is configured such that by opening the opening and closing door 38, a clerk can manually feed the coin C into the storage unit 33, perform maintenance of a configuration disposed inside the housing 31, or the like.

<Configuration of First Coin Handling Apparatus of Money Settlement Apparatus>

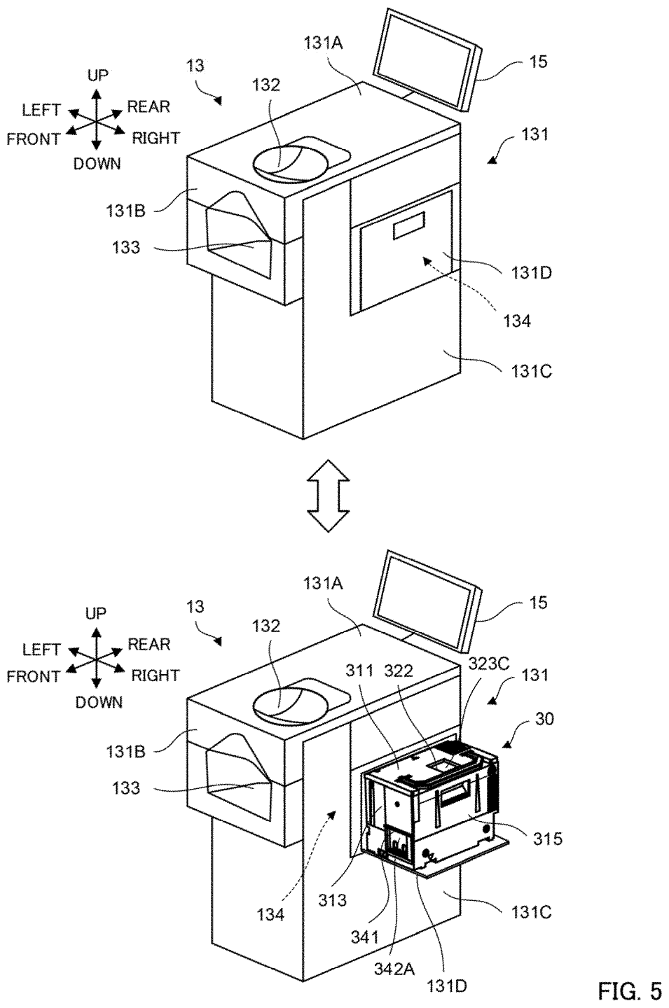

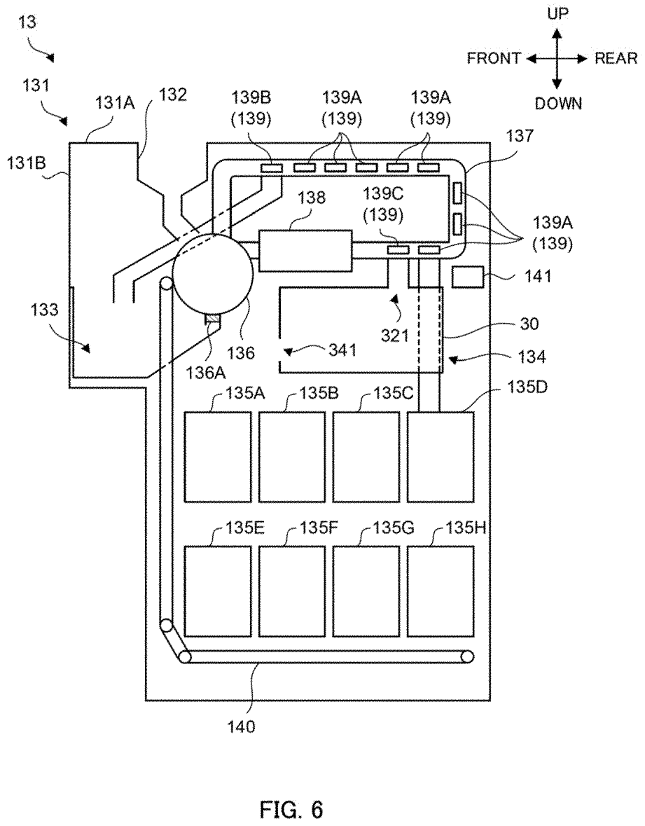

Next, a configuration of the first coin handling apparatus 13 will be described. FIG. 5 is a perspective view of an external appearance of the first coin handling apparatus. FIG. 6 is a schematic diagram illustrating an internal configuration of the first coin handling apparatus. Note that, the arrangement of each configuration of the first coin handling apparatus 13 or the like may be described using the directions indicated in FIG. 5 and FIG. 6.

First, the configuration of the first coin handling apparatus 13 visible from the outside will be described. As illustrated in FIG. 5, the first coin handling apparatus 13 comprises a housing 131, a depositing unit 132, a dispensing unit 133, and a cassette attachment unit 134.

The depositing unit 132 is provided in a front portion of an upper surface portion 131A of the housing 131. That is, the depositing unit 132 is provided on a side on which a customer stands when operating the first coin handling apparatus 13. The depositing unit 132 is configured such that the coin C can be deposited into the first coin handling apparatus 13.

The dispensing unit 133 is provided in a lower portion of a front surface portion 131B of the housing 131. The dispensing unit 133 is configured such that the coin C can be dispensed from the first coin handling apparatus 13.

As illustrated in a diagram on an upper side of FIG. 5, the cassette attachment unit 134 is provided in a rear portion of a right surface portion 131C of the housing 131. The cassette attachment unit 134 is hidden by a cover 131D when the coin transport cassette 30 is not attached to the cassette attachment unit 134, and is exposed when the cover 131D is opened. As illustrated in a diagram on a lower side of FIG. 5, a clerk attaches the coin transport cassette 30 to the cassette attachment unit 134 by pushing the coin transport cassette 30 into the interior of the housing 131 such that the front surface portion 313 of the coin transport cassette 30 faces frontward and the left surface portion 316 faces the right surface portion 131C of the housing 131. By this attachment, the connector 36 of the coin transport cassette 30 is connected to a connector (not illustrated) of the cassette attachment unit 134. Further, the cassette attachment unit 134 is provided with guide rails (not illustrated) extending rightward and leftward. A clerk can easily perform the attachment operation by fitting the guide rails into the first guide grooves 312A of the coin transport cassette 30 and sliding the coin transport cassette 30.

An operation display 15 is connected to the first coin handling apparatus 13. The operation display 15 is formed of a touch screen-type liquid crystal display apparatus, and functions as an operation unit for inputting information on money handling in the first banknote handling apparatus 12 and the first coin handling apparatus 13, and as a display that displays information on money handling. Note that, the operation display 15 may be formed separately from the money settlement apparatus 11 or may be integrally formed with the money settlement apparatus 11. The operation display 15 may also be configured such that the operation unit and the display are provided independently of each other.

Next, an internal configuration of the first coin handling apparatus 13 will be described. As illustrated in FIG. 6, the first coin handling apparatus 13 further comprises storage units 135A, 135B, 135C, 135D, 135E, 135F, 135G and 135H (which may be referred to hereinafter as “storage units 135A to 135H”), a feeding unit 136, a depositing transport unit 137, a recognition unit 138, a plurality of chutes 139, a dispensing transport unit 140, and a control unit 141.

The storage units 135A to 135H are configured so as to be capable of storing the coin C and feeding out the coin C that has been stored. As a mechanism to feed out the coin C in the storage units 135A to 135H, it is possible to exemplify a mechanism in which a rotary disk rotating in an inclined state is used and the coin C is picked up one by one by a plurality of projection members on an outer area of a surface of the rotary disk and is fed out. Denominations that are stored in each of the storage units 135A to 135H are set in advance.

The feeding unit 136 is configured to be capable of receiving the coin C deposited through the depositing unit 132, feeding out the coin C one by one, and causing the coin C to fall into the dispensing unit 133. As a mechanism to feed out the coin C in the feeding unit 136, it is possible to exemplify a mechanism similar to that of the storage units 135A to 135H.

The depositing transport unit 137 transports the coin C fed out of the feeding unit 136.

The recognition unit 138 is provided in the depositing transport unit 137, recognizes denomination, authenticity, fitness, and/or the like of the coin C deposited through the depositing unit 132, and counts the coin C.

The plurality of chutes 139 is provided downstream of the recognition unit 138 in the depositing transport unit 137 in the transport direction of the coin C. The plurality of chutes 139 is provided side by side in a row in the transport direction of the coin C. Of the plurality of chutes 139, eight chutes 139A are configured to be capable of guiding the coin C to any one of the storage units 135A to 135H. One chute 139B is configured to be capable of guiding the coin C to the dispensing unit 133. One chute 139C that is the remaining chute is configured to be capable of guiding the coin C to the coin transport cassette 30. The chutes 139 are normally closed by gates (not illustrated), and guides the coin C to each portion described above by opening the gates. Note that, the number of the chutes 139A may be the same as the number of storage units, and may not be eight.

The dispensing transport unit 140 is provided downward from the feeding unit 136. The dispensing transport unit 140 transports the coin C fed out of the storage units 135A to 135H to the feeding unit 136. The dispensing transport unit 140 transports the coin C, which has been discharged from the coin transport cassette 30 and has fallen, to the feeding unit 136.

The control unit 141 controls entire operation of the first coin handling apparatus 13. The control unit 141 causes depositing processing of the coin C paid by a customer to be performed upon settlement of a commercial product. When the depositing processing is performed, for example, the control unit 141 controls the feeding unit 136 and the depositing transport unit 137 such that the coin C, which has been received through the depositing unit 132 and has fallen into the feeding unit 136, is fed out one by one and is transported. A coin that is transported is subjected to recognition of denomination, authenticity, fitness, and/or the like by the recognition unit 138. The control unit 141 controls the depositing transport unit 137 and the chutes 139 based on a recognition result by the recognition unit 138 such that the coin C which cannot be deposited is discharged as a rejected coin from the dispensing unit 133. The control unit 141 controls the depositing transport unit 137 and the gates such that the coin C which can be deposited is stored in the storage units 135A to 135H for each denomination.

The control unit 141 causes dispensing processing of the coin C to be performed in a case where there is change upon settlement of a commercial product. When the dispensing processing is performed, for example, the control unit 141 controls the storage units 135A to 135H storing the coin C to be dispensed and the dispensing transport unit 140 such that the coin C, which has been fed out of the storage units 135A to 135H and has fallen, is transported to the feeding unit 136. The control unit 141 controls the feeding unit 136 such that a bottom portion 136A of the feeding unit 136 is opened, thereby discharging the coin C into the dispensing unit 133. Note that, the control unit 141 may also cause the coin C, which has been transported to the feeding unit 136, to be fed out into the depositing transport unit 137 and to pass through the recognition unit 138, and then control the gate of the chute 139B, thereby causing the coin C to be discharged into the dispensing unit 133.

The control unit 141 causes the storage units 135A to 135H to be replenished with the coin C stored in the coin transport cassette 30 before a store opens, for example. The control unit 141 causes the coin C stored in the storage units 135A to 135H to be collected to the coin transport cassette 30 after a store closes, for example. Such replenishment processing and collection processing of the coin C will be described later.

<Configuration of Second Coin Handling Apparatus of Depositing and Dispensing Apparatus>

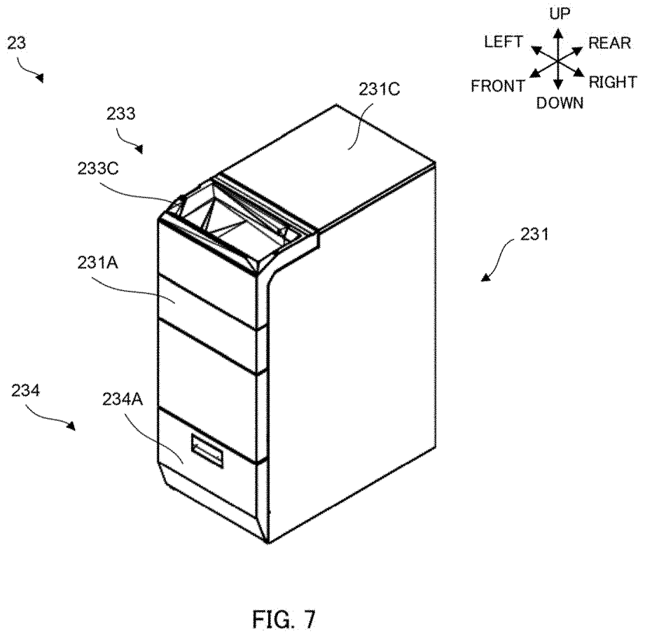

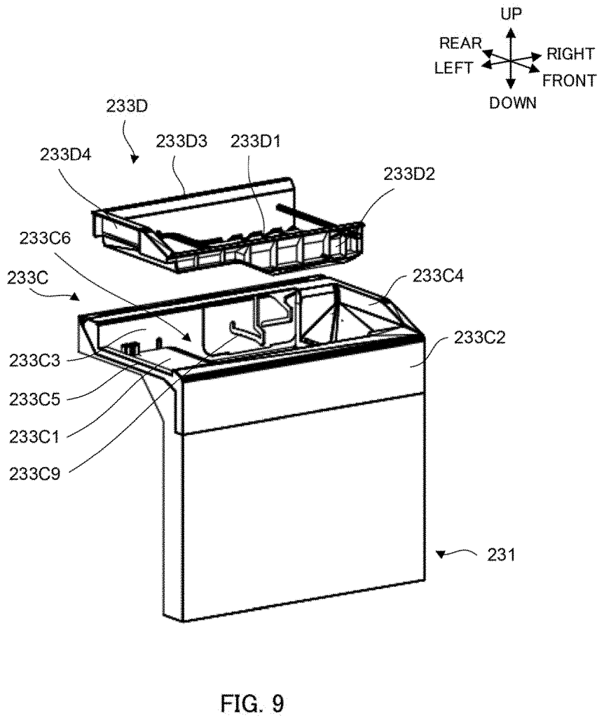

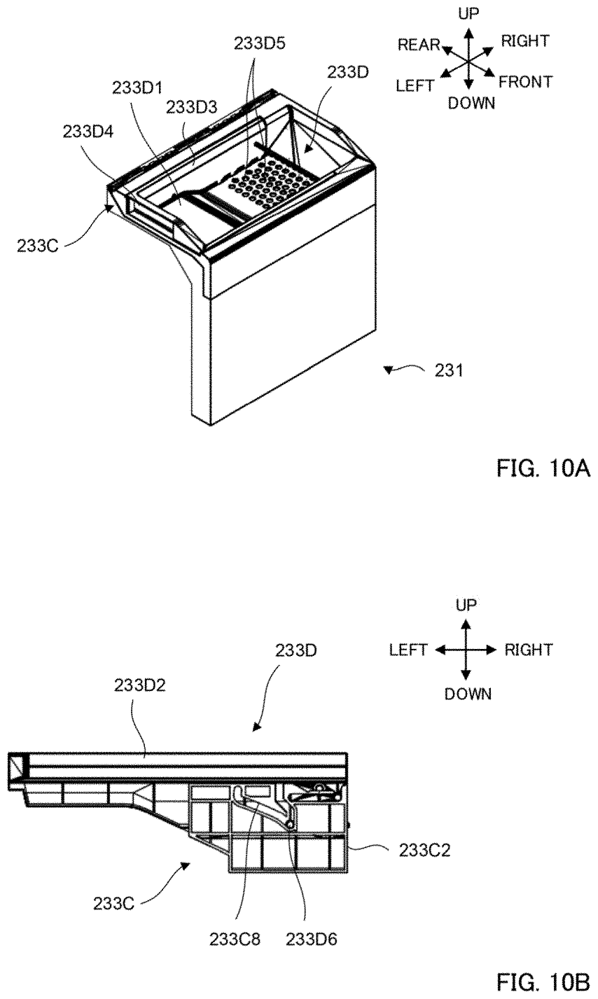

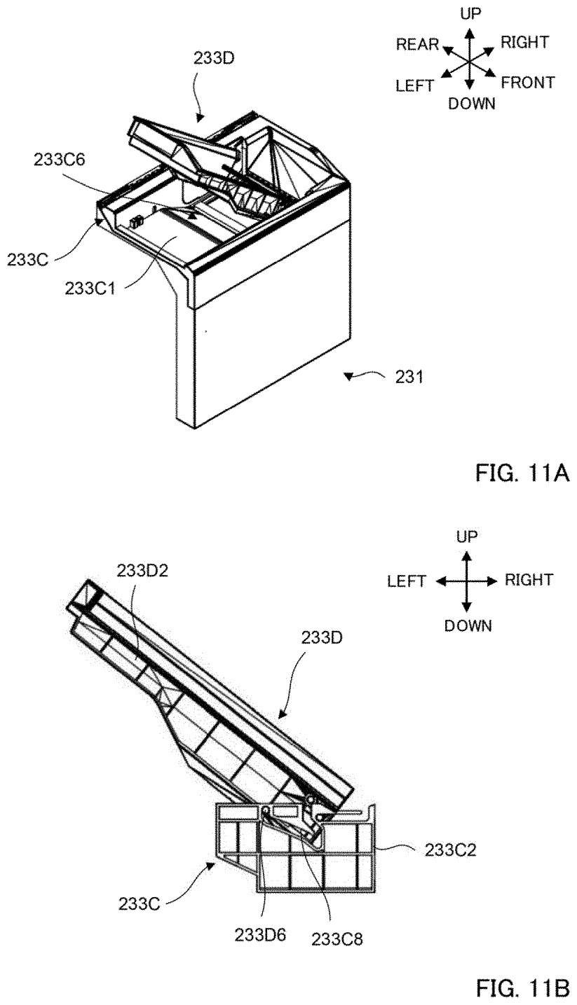

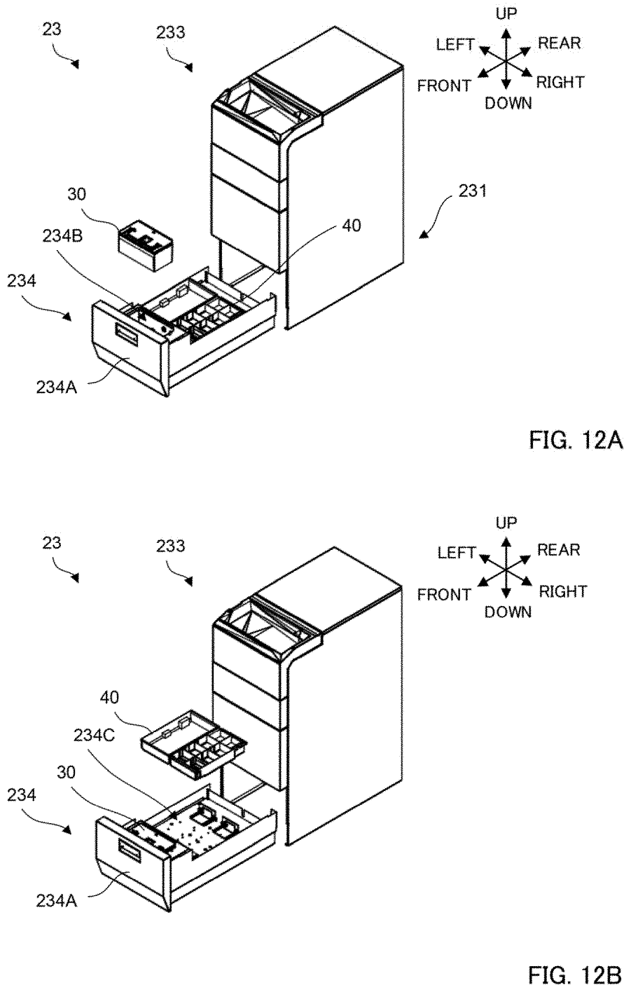

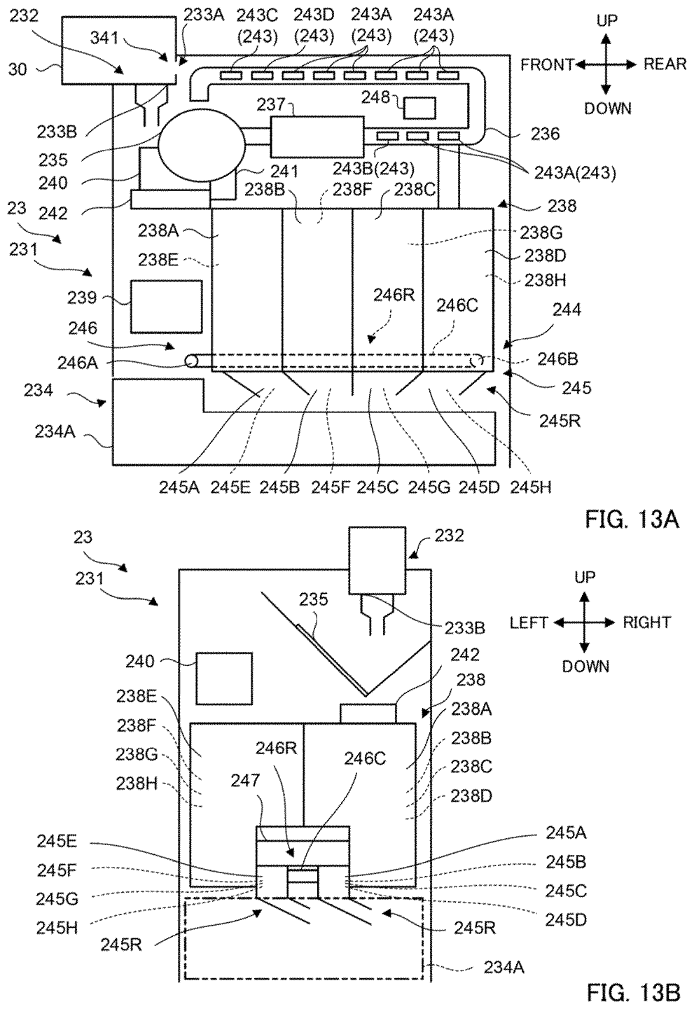

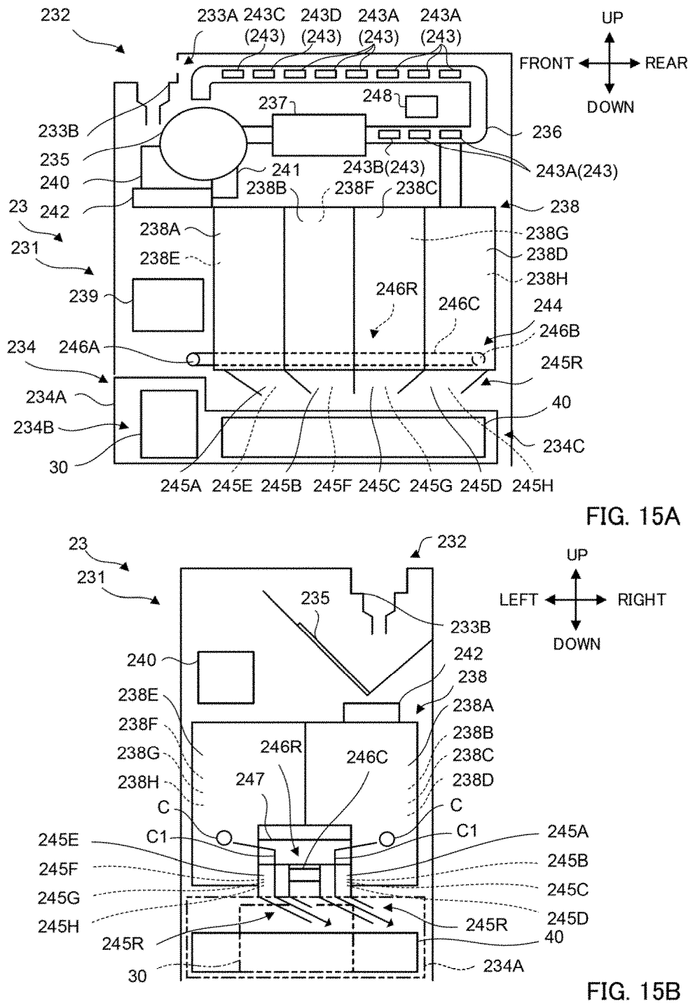

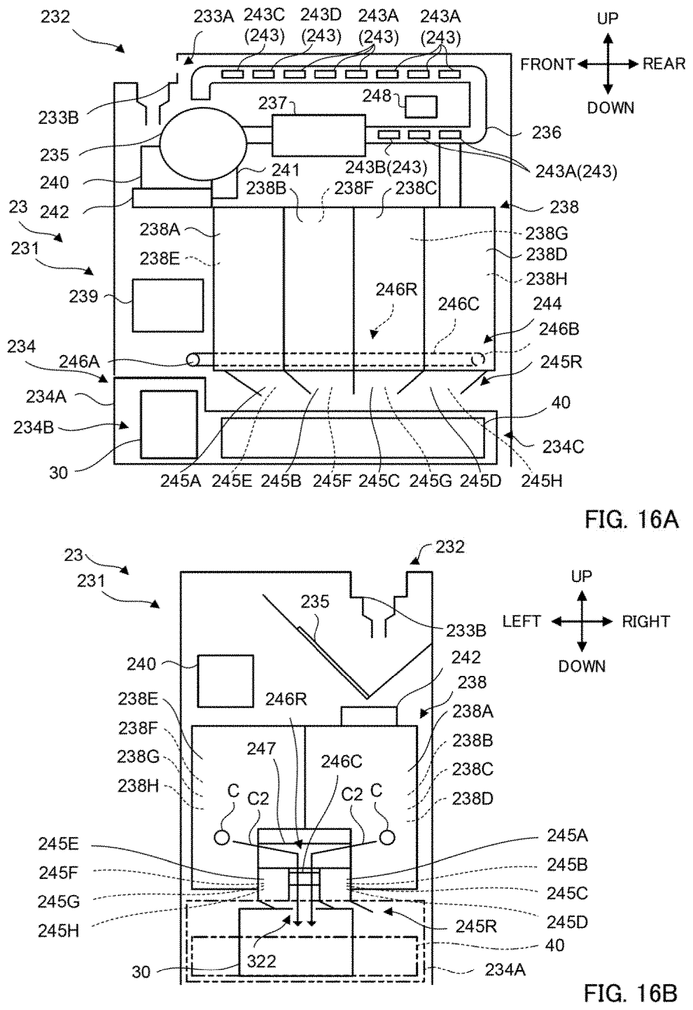

Next, a configuration of the second coin handling apparatus 23 will be described. FIG. 7 is a perspective view of an external appearance of the second coin handling apparatus. FIG. 8A is a perspective view illustrating a state in which a cover of the second coin handling apparatus is opened. FIG. 8B is a perspective view illustrating a state in which the coin transport cassette is attached to the second coin handling apparatus. FIG. 9 is a perspective view illustrating a configuration of the cover and a tray. FIG. 10A is a perspective view illustrating a state in which the tray covers an exposure port of the cover. FIG. 10B is a side view illustrating a position of a first turning pin of the tray in a first pin guide groove of the cover in the state of FIG. 10A. FIG. 11A is a perspective view illustrating a state in which the tray does not cover the exposure port of the cover. FIG. 11B is a side view illustrating a position of the first turning pin of the tray in the first pin guide groove of the cover in the state of FIG. 11A. FIG. 12A is a perspective view illustrating how the coin transport cassette is attached to the second coin handling apparatus. FIG. 12B is a perspective view illustrating how a drawer is attached to the second coin handling apparatus. FIG. 13A is a schematic diagram illustrating an internal configuration of the second coin handling apparatus when viewed from a right side, illustrating a state when coins collected by the coin transport cassette are counted. FIG. 13B is a schematic diagram illustrating the internal configuration of the second coin handling apparatus in the state of FIG. 13A when viewed from a front side. FIG. 14A and FIG. 14B are diagrams for describing a width direction regulating member provided on an upper-side transport path. FIG. 15A is a schematic diagram illustrating the internal configuration of the second coin handling apparatus when viewed from the right side, illustrating a state when the drawer is replenished with a coin. FIG. 15B is a schematic diagram illustrating the internal configuration of the second coin handling apparatus in the state of FIG. 15A when viewed from the front side. FIG. 16A is a schematic diagram illustrating the internal configuration of the second coin handling apparatus when viewed from the right side, illustrating a state when the coin transport cassette is replenished with a coin. FIG. 16B is a schematic diagram illustrating the internal configuration of the second coin handling apparatus in the state of FIG. 16A when viewed from the front side.

First, a configuration of the second coin handling apparatus 23 visible from the outside will be described. As illustrated in FIG. 7, FIG. 8A and FIG. 8B, the second coin handling apparatus 23 comprises a housing 231, a second cassette attachment unit 232, a depositing unit 233, and a dispensing unit 234.

The housing 231 comprises a first front surface portion 231A, and a second front surface portion 231B located upward from the first front surface portion 231A. The second front surface portion 231B is located rearward from the first front surface portion 231A, and is provided such that the surface of the second front surface portion 231B is parallel to the surface of the first front surface portion 231A. The housing 231 comprises a first upper surface portion 231C, and a second upper surface portion 231D located frontward from the first upper surface portion 231C. The second upper surface portion 231D is located downward from the first upper surface portion 231C, and is provided such that the surface of the second upper surface portion 231D is substantially parallel to the surface of the first upper surface portion 231C.

The second cassette attachment unit 232 is formed of a downwardly recessed portion provided in the second upper surface portion 231D. The length of the second cassette attachment unit 232 in the left-right direction is slightly longer than the length of the coin transport cassette 30 in the left-right direction. The second cassette attachment unit 232 is provided with the guide rail 232A extending frontward and rearward. As illustrated in FIG. 8B, the second cassette attachment unit 232 is configured to allow the coin transport cassette 30 to be attached to the second cassette attachment unit 232 with the discharge port 341 facing rearward. The second cassette attachment unit 232 is configured such that, when the coin transport cassette 30 is attached to the second cassette attachment unit 232, the connector 36 of the coin transport cassette 30 is connected to a connector (not illustrated) of the second cassette attachment unit 232. A clerk can easily perform the attachment operation by fitting the guide rail 232A into the second guide groove 316A of the coin transport cassette 30 and sliding the coin transport cassette 30. In addition, it is possible to make it hard for a wrong attachment direction of the coin transport cassette 30 to be taken by fitting the guide rail 232A into the second guide groove 316A when the coin transport cassette 30 is attached to the second cassette attachment unit 232. Further, it is possible to restrain damage or degradation of the connector of the second cassette attachment unit 232 and the connector 36 of the coin transport cassette 30.

The depositing unit 233 is provided in an upper and front portion of the housing 231. That is, the depositing unit 233 is provided on a side on which a clerk stands when operating the second coin handling apparatus 23. The depositing unit 233 is configured such that the coin C can be deposited into the second coin handling apparatus 23. As illustrated in FIG. 8A and FIG. 8B, the depositing unit 233 comprises a first reception port 233A, a second reception port 233B, and a cover 233C.

As illustrated in FIG. 8A, the first reception port 233A is an opening provided in the second front surface portion 231B. The first reception port 233A is provided at a position facing the discharge port 341 of the coin transport cassette 30 attached to the second cassette attachment unit 232. The first reception port 233A is configured to be capable of receiving the coin C discharged rearward from the coin transport cassette 30.

The second reception port 233B is an opening provided in a bottom surface portion of the downwardly recessed portion provided in the second upper surface portion 231D, that is, in a bottom surface portion forming the second cassette attachment unit 232. As illustrated in FIG. 8B, the second reception port 233B is configured to be covered by the coin transport cassette 30 when the coin transport cassette 30 is attached to the second cassette attachment unit 232. That is, when the coin transport cassette 30 is attached to the second cassette attachment unit 232, it is configured such that the coin C cannot be deposited through the second reception port 233B into the second coin handling apparatus 23.

The cover 233C is configured to turn around a turning shaft (not illustrated) provided in the first upper surface portion 231C of the housing 231 and extending rightward and leftward, and is configured to be switchable between a closed state in which the cover 233C covers the first reception port 233A and the second cassette attachment unit 232 as illustrated in FIG. 7 and an open state in which the cover 233C does not cover the first reception port 233A and the second cassette attachment unit 232 as illustrated in FIG. 8A and FIG. 8B. As illustrated in FIG. 9, the cover 233C comprises a bottom surface portion 233C1, a front surface portion 233C2, a rear surface portion 233C3, a right surface portion 233C4, and a left surface portion 233C5.

The bottom surface portion 233C1 is a portion located upward from the second cassette attachment unit 232 when the cover 233C is in the closed state as illustrated in FIG. 7. A recessed portion 233C6 recessed downward is provided on the right side of the center of the bottom surface portion 233C1. The recessed portion 233C6 is provided with an exposure port 233C7 that exposes the second reception port 233B when the cover 233C is in the closed state.

The front surface portion 233C2, the rear surface portion 233C3, the right surface portion 233C4, and the left surface portion 233C5 are portions provided on the front side, the rear side, the right side, and the left side of the bottom surface portion 233C1, respectively. The front surface portion 233C2 is provided with a first pin guide groove 233C8 (see FIG. 10B). A first turning pin 233D6 of a tray 233D to be described later is movably fitted into the first pin guide groove 233C8. The rear surface portion 233C3 is provided with a second pin guide groove 233C9 which is formed to have the same shape as the first pin guide groove 233C8 and into which a second turning pin (not illustrated) of the tray 233D is movably fitted.

A space surrounded by the bottom surface portion 233C1, the front surface portion 233C2, the rear surface portion 233C3, the right surface portion 233C4, and the left surface portion 233C5 is configured to allow the tray 233D to be attached or detached.

As illustrated in FIG. 9, FIG. 10A, FIG. 10B, FIG. 11A, and FIG. 11B, the tray 233D comprises a bottom surface portion 233D1, a front surface portion 233D2, a rear surface portion 233D3, and a left surface portion 233D4. The bottom surface portion 233D1 functions as an exposure port covering portion that covers the exposure port 233C7. The bottom surface portion 233D1 is provided with at least one foreign object collecting hole 233D5 having a size that allows a foreign object to pass therethrough and does not allow the coin C to pass therethrough. Further, the bottom surface portion 233D1 is provided with a groove (not illustrated) that guides a foreign object to the foreign object collecting hole 233D5. The bottom surface portion 233D1 is provided with a foreign object storage unit (not illustrated) that stores a foreign object having passed through the foreign object collecting hole 233D5. The tray 233D is provided with the first turning pin 233D6 protruding frontward from the front surface portion 233D2. The tray 233D is provided with the second turning pin (not illustrated) protruding rearward from the rear surface portion 233D3.

A clerk can realize a state in which the bottom surface portion 233D1 covers the exposure port 233C7 of the cover 233C as illustrated in FIG. 10B by moving the tray 233D such that the position of the first turning pin 233D6 in the first pin guide groove 233C8 and the position of the second turning pin in the second pin guide groove become the positions illustrated in FIG. 10A. In the state illustrated in FIG. 10B, the exposure port 233C7 is covered by the bottom surface portion 233D1, and a clerk therefore cannot deposit the coin C into the second coin handling apparatus 23 via the exposure port 233C7 and the second reception port 233B.

A clerk can realize a state in which the bottom surface portion 233D1 does not cover the exposure port 233C7 of the cover 233C as illustrated in FIG. 11B by moving the tray 233D such that the position of the first turning pin 233D6 in the first pin guide groove 233C8 and the position of the second turning pin in the second pin guide groove become the positions illustrated in FIG. 11A. In the state illustrated in FIG. 11B, the exposure port 233C7 is not covered by the bottom surface portion 233D1, and a clerk therefore can deposit the coin C into the second coin handling apparatus 23 via the exposure port 233C7 and the second reception port 233B.

As illustrated in FIG. 12A, the dispensing unit 234 comprises a drawer portion 234A that can be drawn from a lower portion of the housing 231 onto a side of a clerk. A first cassette attachment unit 234B is provided in a front-side portion in the drawer portion 234A. As illustrated in FIG. 12B, the coin transport cassette 30 is attached to the first cassette attachment unit 234B. The first cassette attachment unit 234B is configured such that, when the coin transport cassette 30 is attached to the first cassette attachment unit 234B, the connector 36 of the coin transport cassette 30 is connected to a connector (not illustrated) of the first cassette attachment unit 234B. As illustrated in FIG. 12B, a drawer attachment unit 234C is provided rearward from the first cassette attachment unit 234B in the drawer portion 234A. As illustrated in FIG. 12A, the drawer 40 is attached to the drawer attachment unit 234C. That is, the first cassette attachment unit 234B is provided at a position different from a position of the drawer attachment unit 234C. Specifically, the first cassette attachment unit 234B is configured to allow the coin transport cassette 30 to be attached to the first cassette attachment unit 234B at a position frontward from a position of the drawer 40. Such a configuration makes it possible to attach the coin transport cassette 30 to the first cassette attachment unit 234B when the drawer 40 is attached to the drawer attachment unit 234C.

Next, an internal configuration of the second coin handling apparatus 23 will be described. As illustrated in FIG. 13A and FIG. 13B, the second coin handling apparatus 23 further comprises a feeding unit 235, an upper-side transport unit 236, a recognition unit 237, a storage unit 238, a reject unit 239, an overflow storage unit 240, a forged coin storage unit 241, a return unit 242, a plurality of upper-side chutes 243, a lower-side transport unit 244, a switching unit 247, and a control unit 248.

The feeding unit 235 is configured to be capable of receiving the coin C deposited from the coin transport cassette 30 via the first reception port 233A and the coin C deposited through the second reception port 233B, feeding out the coin C one by one, and causing the coin C to fall into the return unit 242. As a mechanism to feed out the coin C in the feeding unit 235, it is possible to exemplify a configuration similar to that of the storage units 135A to 135H of the first coin handling apparatus 13.

The upper-side transport unit 236 is an example of a second transport unit that transports the coin C fed out of the feeding unit 235. As illustrated in FIG. 14A, a transport path 236A of the upper-side transport unit 236 comprises a bottom surface portion 236A1 and a sidewall portion 236A2. A plurality of tracking sensors 236B that detects a passage of the coin C is provided at predetermined positions on the transport path 236A. The tracking sensor 236B may be formed of an optical sensor or may be formed of a magnetic sensor.

The upper-side transport unit 236 comprises transport pins 236C for pushing and transporting the coin C on the transport path 236A. The transport pins 236C are provided at positions facing the transport path 236A, and are fixed at predetermined intervals to a moving member 236D that has a belt-like shape and moves along the transport path 236A. Such a configuration makes it possible to transport a plurality of the coins C at predetermined intervals on the transport path 236A.

A width direction regulating member 236E is provided at a position facing the bottom surface portion 236A1 of the transport path 236A. The width direction regulating member 236E comprises an arm portion 236E1 having a long edge shape, and a pressing portion 236E2 provided on a side of one end of the arm portion 236E1 in a long edge direction. A side of the other end of the arm portion 236E1 in the long edge direction is turnably supported by a turning shaft 236E3. The arm portion 236E1 is urged in a clockwise direction in FIG. 14A by an urging member (not illustrated). The arm portion 236E1 is provided such that a width between the pressing portion 236E2 and the bottom surface portion 236A1 is a width W in a case where the pressing portion 236E2 is not urged in a counterclockwise direction by the coin C.

With such a configuration, in a case where the coin C having a diameter smaller than the width W is transported, the width direction regulating member 236E assumes an attitude as illustrated in FIG. 14A since the pressing portion 236E2 is not urged in the counterclockwise direction even when the coin C comes into contact with the pressing portion 236E2. In a case where the coin C having a diameter larger than the width W is transported, the width direction regulating member 236E assumes an attitude as illustrated in FIG. 14B since the pressing portion 236E2 is urged in the counterclockwise direction by the coin C. When the coin C having a diameter larger than the width W has passed through a position facing the pressing portion 236E2, the attitude of the width direction regulating member 236E returns to the state illustrated in FIG. 14A.

In a case where the width direction regulating member 236E as such is not provided in the upper-side transport unit 236, the tracking sensor 236B cannot detect that the coin C is passing through when the coin C is transported as indicated by a two-dot chain line in FIG. 14A. In a case where the width direction regulating member 236E is provided, on the other hand, even when the coin C is transported as indicated by the two-dot chain line in FIG. 14A, the tracking sensor 236B can detect that the coin C is passing through by pushing the coin C onto a side of the bottom surface 236A1 by the pressing portion 236E2 as indicated by a solid line in FIG. 14A.

As illustrated in FIG. 13A, the recognition unit 237 is provided in the upper-side transport unit 236, recognizes denomination, authenticity, fitness, and/or the like of the coin C deposited through the depositing unit 233, and counts the coin C.

The storage unit 238 comprises storage boxes 238A, 238B, 238C, 238D, 238E, 238F, 238G and 238H (which may be referred to hereinafter as “storage boxes 238A to 238H”). The storage boxes 238A to 238H are configured to be capable of storing the coin C and feeding out the coin C that has been stored. The storage boxes 238A to 238D are provided so as to be side by side in the front-rear direction on the right side in the housing 231. The storage boxes 238E to 238H are provided so as to be side by side in the front-rear direction on the left side in the housing 231. In FIG. 13A, the storage boxes 238E to 238H are hidden behind the storage boxes 238A to 238D. In FIG. 13B, the storage boxes 238B to 238D and 238F to 238H are hidden behind the storage boxes 238A and 238E. Denominations that are stored in the storage boxes 238A to 238H, respectively, are set in advance. As a mechanism to feed out the coin C in the storage boxes 238A to 238H, it is possible to exemplify a mechanism similar to that of the storage units 135A to 135H.

The reject unit 239 stores, as a rejected coin, the coin C recognized not as a coin to be handled or as unrecognizable by the recognition unit 237. The reject unit 239 is configured to be drawable from a side of a front surface of the housing 231 by opening a cover (not illustrated) of the housing 231.

The overflow storage unit 240 stores, as an overflow coin, the coin C that cannot be held in a case where the holding number of the coin C in the storage boxes 238A to 238H exceeds a predetermined holding number that has been set. The overflow storage unit 240 is configured to be drawable from the side of the front surface of the housing 231.

The forged coin storage unit 241 stores the coin C recognized as a forged coin by the recognition unit 237. The forged coin storage unit 241 is configured to be drawable from the side of the front surface of the housing 231.

The return unit 242 stores the coin C that has fallen from the feeding unit 235. The return unit 242 is configured to be drawable from the side of the front surface of the housing 231.

The upper-side chutes 243 are provided downstream of the recognition unit 237 in the upper-side transport unit 236 in the transport direction of the coin C. The upper-side chutes 243 are provided side by side in a row in the transport direction of the coin C. Of the plurality of upper-side chutes 243, eight upper-side chutes 243A are configured to be capable of guiding the coin C to any one of the storage boxes 238A to 238H. Another chute 243B is configured to be capable of guiding a rejected coin to the reject unit 239. Yet another upper-side chute 243C is configured to be capable of guiding an overflow coin to the overflow storage unit 240. One upper-side chute 243D that is the remaining upper-side chute 243 is configured to be capable of guiding a forged coin to the forged coin storage unit 241. The upper-side chutes 243 are normally closed by gates (not illustrated), and guide the coin C to each portion described above by opening the gates.

The lower-side transport unit 244 is an example of a first transport unit that transports the coin C fed out of the storage unit 238 to the drawer 40 attached to the drawer attachment unit 234C or the coin transport cassette 30 attached to the first cassette attachment unit 234B. The lower-side transport unit 244 comprises a first route forming portion 245 and a second route forming portion 246.

The first route forming portion 245 forms a first route 245R that guides the coin C fed out of the storage unit 238 to the drawer 40 attached to the drawer attachment unit 234C. The first route forming portion 245 comprises drawer chutes 245A, 245B, 245C, 245D, 245E, 245F, 245G and 245H (which may be referred to hereinafter as “drawer chutes 245A to 245H”). The drawer chutes 245A to 245H are provided one by one downward from the storage boxes 238A to 238H, respectively. In FIG. 13A, the drawer chutes 245E to 245H are hidden behind the drawer chutes 245A to 245D. In FIG. 13B, the drawer chutes 245B to 245D and 245F to 245H are hidden behind the drawer chutes 245A and 245E. The drawer chutes 245A to 245H are configured to be capable of guiding the coin C stored in the storage boxes 238A to 238H to the drawer 40 attached to the drawer attachment unit 234C.

The second route forming portion 246 forms a second route 246R that guides the coin C fed out of the storage unit 238 to the coin transport cassette 30 attached to the first cassette attachment unit 234B. The second route forming portion 246 is provided between a row formed of the drawer chutes 245A to 245D in the front-rear direction and a row formed of the drawer chutes 245E to 245H in the front-rear direction. The second route forming portion 246 comprises a transport motor (not illustrated), a driving pulley 246A, a driven pulley 246B, and a transport belt 246C. The transport motor is driven by control of the control unit 248. The driving pulley 246A is provided on a rotating shaft of the transport motor so as to extend rightward and leftward in a front and lower portion of the housing 231. The driven pulley 246B is received by a bearing (not illustrated) so as to extend rightward and leftward in a rear and lower portion of the housing 231. The transport belt 246C is wound around the driving pulley 246A and the driven pulley 246B. The transport belt 246C is configured to be capable of guiding the coin C stored in the storage boxes 238A to 238H to the second reception port 322 of the coin transport cassette 30 attached to the first cassette attachment unit 234B.

The switching unit 247 is driven by control of the control unit 248. The switching unit 247 switches a guide destination of the coin C stored in the storage boxes 238A to 238H to the first route 245R (the drawer chutes 245A to 245H) as illustrated in FIG. 15A and FIG. 15B or the second route 246R (the transport belt 246C) as illustrated in FIG. 16A and FIG. 16B.

The control unit 248 controls entire operation of the second coin handling apparatus 23. The control unit 248 counts coins collected from the first coin handling apparatus 13 by the coin transport cassette 30 and the coin C collected from the POS register apparatus 14 by the drawer 40. The control unit 248 replenishes the coin transport cassette 30 or the drawer 40 with the coin C stored in the storage boxes 238A to 238H. Such counting processing and replenishment processing of the coin C will be described later.

Further, an operation display (not illustrated) is connected to the second coin handling apparatus 23. As the operation display, it is possible to exemplify a configuration similar to that of the operation display 15 connected to the first coin handling apparatus 13. The second coin handling apparatus 23 functions as an operation unit for inputting information on money handling in the second banknote handling apparatus 22 and the second coin handling apparatus 23, and as a display displays information on money handling.

<Operation of Money Handling System>

### (Counting Processing of Coin Collected By Coin Transport Cassette in Second Coin Handling Apparatus)

First, as operation of the money handling system 1, counting processing of the coin C collected from the first coin handling apparatus 13 by the coin transport cassette 30 in the second coin handling apparatus 23 will be described.

As illustrated in FIG. 8A, a clerk opens the cover 233C to expose the second cassette attachment unit 232. The clerk attaches the coin transport cassette 30, in which the first reception port 321, the second reception port 322 and the discharge port 341 are closed, to the second cassette attachment unit 232 as illustrated in FIG. 8B, FIG. 13A and FIG. 13B. When the coin transport cassette 30 is attached to the second cassette attachment unit 232, the second coin handling apparatus 23 begins to supply power to the coin transport cassette 30 via the connector of the second cassette attachment unit 232. The control unit 248 of the second coin handling apparatus 23 controls the coin transport cassette 30 such that the coin C stored in the coin transport cassette 30 is discharged.

The control unit 248 controls the opening and closing motor of the discharge port opening and closing unit 342 of the coin transport cassette 30 such that the discharge port 341 is opened. Next, the control unit 248 controls the transport motor of the feeding unit 35 of the coin transport cassette 30 such that the transport belt 351C rotates, thereby sequentially discharging the coin C stored in the storage unit 33 so as to be fed out of the discharge port 341. When a sensor (not illustrated) detects that all of the coin C stored in the storage unit 33 has been discharged, the control unit 248 controls the transport motor of the feeding unit 35 to cause the rotation of the transport belt 351C to end, and controls the opening and closing motor of the discharge port opening and closing unit 342 such that the discharge port 341 is closed.

On the other hand, the coin C fed out of the coin transport cassette 30 passes through the first reception port 233A, and falls into the feeding unit 235 via a feeding mechanism (not illustrated) provided in the first reception port 233A on an inner side of the housing 231. The control unit 248 controls the feeding unit 235 and the upper-side transport unit 236 such that the coin C fed out of the coin transport cassette 30 is transported. The coin that is transported is subjected to recognition of denomination, authenticity, fitness, and/or the like by the recognition unit 237. The control unit 248 controls the upper-side transport unit 236 and the gates based on a recognition result by the recognition unit 237 such that the coin C that can be deposited is stored in the storage boxes 238A to 238H for each denomination, and that a rejected coin, an overflow coin, and a forged coin are stored in the reject unit 239, the overflow storage unit 240, and the forged coin storage unit 241, respectively. When the counting of all of the coin C stored in the coin transport cassette 30 is completed, the control unit 248 transmits information on the denominations and number of the coin C, which has been counted, to the money management apparatus 25. Thereafter, a clerk detaches the coin transport cassette 30 from the second coin handling apparatus 23, and closes the cover 233C as illustrated in FIG. 7.

(Counting Processing of Coin Collected By Drawer in Second Coin Handling Apparatus)

Next, as operation of the money handling system 1, counting processing of the coin C collected by the drawer 40 in the second coin handling apparatus 23 will be described. Note that, a difference between the counting processing of the coin C collected by the drawer 40 and the counting processing of the coin C collected by the coin transport cassette 30 lies in processing when placing the coin C into the housing 231 of the second coin handling apparatus 23, so that processing after the coin C is placed into the housing 231 will be described in a simplified manner.

In the states illustrated in FIG. 7, FIG. 10A and FIG. 10B, the cover 233C is closed and the tray 233D covers the exposure port 233C7 of the cover 233C so that the coin transport cassette 30 cannot be attached to the second cassette attachment unit 232, and that the coin C cannot be deposited through the second reception port 233B into the second coin handling apparatus 23 either. In this state, a clerk inserts the coin C collected by the drawer 40 into the trays 233D. Next, the clerk turns the tray 233D so as to raise a side of a left end thereof, and causes the tray 233D to expose the exposure port 233C7 of the cover 233C as illustrated in FIG. 11A and FIG. 11B, whereby the coin C slides down on the bottom surface portion 233D1 and passes through the exposure port 233C7 and the second reception port 233B. At this time, a foreign object such as dust is stored in the foreign object storage unit via the foreign object collecting hole 233D5. Thus, a failure of the second coin handling apparatus 23 due to a foreign object can be restrained by storing a foreign object in the foreign object storage unit. Note that, when all of the coin C in the drawer 40 cannot be stored in the tray 233D at a time, the tray 233D that has been inclined may be returned to the original state to repeat the procedure described above.

The coin C that has passed through the second reception port 233B falls into the feeding unit 235 via a feeding mechanism (not illustrated) provided in the second reception port 233B on an inner side of the housing 231, and is stored in the storage boxes 238A to 238H, the reject unit 239, the overflow storage unit 240, or the forged coin storage unit 241 based on a recognition result by the recognition unit 237. When the delivery of all of the coin C inserted into the tray 233D to the second reception port 233B is completed, a clerk returns the tray 233D to the state illustrated in FIG. 10A and FIG. 10B.

(Replenishment Processing of Coin Transport Cassette and Drawer with Coin in Second Coin Handling Apparatus)

Next, as operation of the money handling system 1, replenishment processing of the coin transport cassette 30 and the drawer 40 with the coin C in the second coin handling apparatus 23 will be described.

A clerk draws the drawer portion 234A of the second coin handling apparatus 23 onto a side of the clerk, and attaches the drawer 40, which is empty, to the drawer attachment unit 234C as illustrated in FIG. 12A. Subsequently, the clerk attaches the coin transport cassette 30, which is empty and in which the first reception port 321, the second reception port 322, and the discharge port 341 are closed, to the first cassette attachment unit 234B. As illustrated in FIG. 15A, FIG. 15B, FIG. 16A, and FIG. 16B, the clerk pushes and inserts the drawer portion 234A into the housing 231 to realize a state in which the coin C can be stored in the coin transport cassette 30 and the drawer 40. When the drawer portion 234A is inserted into the housing 231, the second coin handling apparatus 23 begins to supply power to the coin transport cassette 30 via the connector of the first cassette attachment unit 234B. The control unit 248 of the second coin handling apparatus 23 controls the coin transport cassette 30 such that the second reception port 322 of the coin transport cassette 30 is opened.

The control unit 248 causes the first reception port 321 and the second reception port 322 to open simultaneously by controlling the opening and closing motor of the reception port opening and closing unit 323 of the coin transport cassette 30 to move the reception port blocking member 323A.

When the first reception port 321 and the second reception port 322 of the coin transport cassette 30 are opened, the control unit 248 causes the coin transport cassette 30 and the drawer 40 to be replenished with the coin C of predetermined denominations by a predetermined number.

For example, the control unit 248 controls the storage boxes 238A to 238H and the switching unit 247 such that the coin C fed out of the storage boxes 238A to 238H is guided to the first route 245R (the drawer chutes 245A to 245H) as indicated by an arrow C1 in FIG. 15B. The drawer 40 is replenished with a coin guided to the first route 245R. Further, when the replenishing handling of the drawer 40 with the coin C in the storage boxes 238A to 238H is completed, the control unit 248 controls the storage boxes 238A to 238H and the switching unit 247 such that the coin C fed out of the storage boxes 238A to 238H is guided to the second route 246R (the transport belt 246C) as indicated by an arrow C2 in FIG. 16B. The control unit 248 further controls the transport motor of the second route forming portion 246 such that the coin transport cassette 30 is replenished with the coin C guided onto the transport belt 246C via the second reception port 322. In this manner, the coin transport cassette 30 and the drawer 40 can be replenished with the coin C in the storage boxes 238A to 238H without detaching the coin transport cassette 30 and the drawer 40 from the second coin handling apparatus 23.

Note that, when the drawer 40 is being replenished with the coin C in at least one arbitrary storage box of the storage boxes 238A to 238H, the control unit 248 may control the switching unit 247 such that the coin transport cassette 30 is replenished with the coin C in all the remaining storage boxes.

When the replenishment processing of the coin transport cassette 30 and the drawer 40 with the coin C is completed, the control unit 248 controls the coin transport cassette 30 such that the second reception port 322 of the coin transport cassette 30 is closed.

The control unit 248 controls the opening and closing motor of the reception port opening and closing unit 323 of the coin transport cassette 30 to cause the reception port blocking member 323A to move, thereby closing the first reception port 321 and the second reception port 322 simultaneously.

Thereafter, a clerk draws the drawer portion 234A onto a side of the clerk, and detaches the coin transport cassette 30 and the drawer 40 from the second coin handling apparatus 23.

(Replenishment Processing of Coin from Coin Transport Cassette in First Coin Handling Apparatus)

Next, as operation of the money handling system 1, the replenishment processing of the coin C from the coin transport cassette 30 in the first coin handling apparatus 13 will be described. Note that, processing similar to the processing with the second coin handling apparatus 23 described above will be briefly described.

A clerk opens the cover 131D of the housing 131 of the first coin handling apparatus 13, and attaches the coin transport cassette 30 replenished with the coin C to the cassette attachment unit 134 as illustrated in FIG. 6. When the coin transport cassette 30 is attached to the cassette attachment unit 134, the first coin handling apparatus 13 begins to supply power to the coin transport cassette 30 via the connector of the cassette attachment unit 134. The control unit 141 of the first coin handling apparatus 13 controls the coin transport cassette 30 such that the discharge port 341 of the coin transport cassette 30 opens to discharge the coin C stored in the storage unit 33.

When a required amount of the coin C stored in the storage unit 33 is discharged, the control unit 141 controls the coin transport cassette 30 such that the rotation of the transport belt 351C is ended and that the discharge port 341 is closed.

On the other hand, the coin C fed out of the coin transport cassette 30 falls into the dispensing transport unit 140. The control unit 141 of the first coin handling apparatus 13 controls the dispensing transport unit 140 such that the coin C fed out of the coin transport cassette 30 is transported to the feeding unit 136. The control unit 141 controls the feeding unit 136 and the depositing transport unit 137 such that the coin C fed out of the feeding unit 136 is fed out one by one and transported. The coin C that is transported is subjected to recognition of denomination by the recognition unit 138. The control unit 141 controls the depositing transport unit 137 and the gates of the chutes 139 based on a recognition result by the recognition unit 138 such that the coin C is stored in the storage units 135A to 135H for each denomination.

After the replenishment processing of the required amount of the coin C stored in the coin transport cassette 30 is completed, a clerk may detach the coin transport cassette 30 from the first coin handling apparatus 13 before the start of settlement processing for a customer, or may cause the first coin handling apparatus 13 to perform settlement processing for a customer while the coin transport cassette 30 is attached to the first coin handling apparatus 13.

(Collection Processing of Coin to Coin Transport Cassette in First Coin Handling Apparatus)

Next, as operation of the money handling system 1, collection processing of the coin C to the coin transport cassette 30 in the first coin handling apparatus 13 will be described. Note that, processing similar to the processing with the second coin handling apparatus 23 described above will be briefly described.

In a state in which the coin transport cassette 30 is attached to the cassette attachment unit 134, the control unit 141 of the first coin handling apparatus 13 controls the coin transport cassette 30 such that the first reception port 321 of the coin transport cassette 30 is opened.

The coin transport cassette 30 opens the first reception port 321 and the second reception port 322 simultaneously by control of the control unit 141.

When the first reception port 321 and the second reception port 322 of the coin transport cassette 30 are opened, the control unit 141 causes the coin C stored in the storage units 135A to 135H to be collected by the coin transport cassette 30.

The control unit 141 controls the storage units 135A to 135H and the dispensing transport unit 140 such that the coin C fed out of the storage units 135A to 135H is transported to the feeding unit 136. The control unit 141 controls the feeding unit 136, the depositing transport unit 137 and the gates such that the coin C is collected to the coin transport cassette 30 via the first reception port 321.

When the collection processing of the coin C to the coin transport cassette 30 is completed, the control unit 141 controls the coin transport cassette 30 such that the first reception port 321 of the coin transport cassette 30 is closed.

The coin transport cassette 30 closes the first reception port 321 and the second reception port 322 simultaneously by control of the control unit 141. Thereafter, a clerk detaches the coin transport cassette 30 from the first coin handling apparatus 13.

<Working Effect of Embodiment>

The second coin handling apparatus 23 comprises the drawer attachment unit 234C; and the first cassette attachment unit 234B provided at a position different from a position of the drawer attachment unit 234C and configured to allow the coin transport cassette 30 to be attached to the first cassette attachment unit 234B when the drawer 40 is attached to the drawer attachment unit 234C. Thus, after the coin C is stored in the drawer 40, the coin C can be stored in the coin transport cassette 30 without detaching the drawer 40 from the second coin handling apparatus 23. Accordingly, time for replenishing the coin transport cassette 30 and the drawer 40 with the coin C can be reduced.

The drawer attachment unit 234C is configured such that the drawer 40 attached to the drawer attachment unit 234C is located at a position downward from the storage unit 238. Thus, the coin C fed out of the storage unit 238 can be stored in the drawer 40 by the own weight of the coin C. The first cassette attachment unit 234B is configured such that the coin transport cassette 30 attached to the first cassette attachment unit 234B is located at a side of the drawer 40 attached to the drawer attachment unit 234C. Accordingly, it is possible to restrain the second coin handling apparatus 23 from becoming high.

The first cassette attachment unit 234B is configured such that the coin transport cassette 30 attached to the first cassette attachment unit 234B is located on a side of the depositing unit 233 (frontward) relative to the drawer 40 attached to the drawer attachment unit 234C. Thus, a clerk is capable of easily attaching the coin transport cassette 30 to the first cassette attachment unit 234B.

The lower-side transport unit 244 comprises the first route forming portion 245 forming the first route 245R, and the second route forming portion 246 forming the second route 246R. Thus, the coin C can be surely stored in the drawer 40 or the coin transport cassette 30 via the first route 245R or the second route 246R, both of which are formed separately from each other.

The second route 246R is provided so as to extend from below the storage boxes 238A to 238H toward a side (frontward) of the drawer 40 attached to the drawer attachment unit 234C. Thus, the coin C can be surely stored in the coin transport cassette 30 provided frontward of the drawer 40.

The storage boxes 238A to 238D are provided side by side in a horizontal direction (front-rear direction), and the storage boxes 238E to 238H are provided side by side in the horizontal direction (front-rear direction) on a left side of the storage boxes 238A to 238D. The second route 246R is provided between a row of the storage boxes 238A to 238D and a row of the storage boxes 238E to 238H. Thus, the distance between the storage boxes 238A to 238H and the second route 246R can be shortened.

The first route forming portion 245 guides the coin C to the drawer 40 by the drawer chutes 245A to 245H. Thus, the coin C can be guided to the drawer 40 with a simple configuration.

The second route forming portion 246 comprises the transport belt 246C that guides the coin C to the coin transport cassette 30. Thus, the coin C can be transported in the horizontal direction by the transport belt 246C to be guided to the coin transport cassette 30, and it is possible to restrain the second coin handling apparatus 23 from becoming high.

The second coin handling apparatus 23 is configured to receive the coin C in the coin transport cassette 30 attached to the second cassette attachment unit 232, at the first reception port 233A, and to store the coin C, which has been received, in the storage unit 238. Thus, it is possible to achieve multi-functionality of the second coin handling apparatus 23.

The coin transport cassette 30 is configured to transport the coin C in a horizontal direction with the transport mechanism 351 to discharge the coin C from the discharge port 341. Thus, it is possible to restrain a large amount of the coin C from being deposited into the second coin handling apparatus 23 at a time, and it is possible to restrain the coin C from being clogged in the second coin handling apparatus 23.

The first reception port 233A of the second coin handling apparatus 23 is provided at a position facing the discharge port 341 of the coin transport cassette 30 attached to the second cassette attachment unit 232. Thus, a member for guiding the coin C discharged from the discharge port 341 to the first reception port 233A becomes unnecessary, and it is possible to restrain the configuration of the second coin handling apparatus 23 from becoming complicated and to restrain cost from increasing.

The second coin handling apparatus 23 is configured to receive the coin C at the second reception port 233B and to store the coin C, which has been received, in the storage unit 238. The second cassette attachment unit 232 is configured such that the second reception port 233B is blocked by the coin transport cassette 30 attached to the second cassette attachment unit 232. Thus, when the coin C in the coin transport cassette 30 is being deposited into the second coin handling apparatus 23, it is possible to prevent the coin C from being deposited from a portion other than the coin transport cassette 30, for example, the drawer 40.

The exposure port 233C7 that exposes the second reception port 233B is provided in the cover 233C that covers the second cassette attachment unit 232. Thus, for example, the coin C in the drawer 40 can be deposited into the second coin handling apparatus 23 without opening the cover 233C. Further, when the coin C in the drawer 40 is being deposited into the second coin handling apparatus 23, it is possible to prevent the coin C from being deposited from the coin transport cassette 30.

The cover 233C is provided with the tray 233D having a function as an exposure port covering portion that covers the exposure port 233C7. Thus, it is possible to prevent a foreign object other than the coin C from entering the second coin handling apparatus 23 through the first reception port 233A and the second reception port 233B.

[Variation of Embodiment]

It goes without saying that the present disclosure is not limited to those indicated in the embodiment described thus far, and various modifications can be made without departing from the spirit of the present disclosure. The embodiment described above and a variation that is indicated below may be combined in any way as long as it is applicable.

The drawer attachment unit 234C may also be configured such that the drawer 40 attached to the drawer attachment unit 234C is located at a side of (frontward, rearward, rightward or leftward from) or upward from the storage unit 238, and the first cassette attachment unit 234B may also be configured such that the coin transport cassette 30 attached to the first cassette attachment unit 234B is located upward or downward, or rearward, rightward or leftward from the drawer 40 attached to the drawer attachment unit 234C.

The second route 246R may also be formed of a chute and cause the coin C to be guided downward from the storage boxes 238A to 238H with the chute to be stored in the coin transport cassette 30.

The second route 246R may also be provided downward or upward from or at a side of (frontward, rearward, rightward or leftward from) the row of the storage boxes 238A to 238D or the row of the storage boxes 238E to 238H. Further, the first route 245R, the second route 246R, and the first route 245R are provided side by side in this order from the right side to the left side of the second coin handling apparatus 23, but may also be provided side by side in another order, such as the first route 245R, the first route 245R, and the second route 246R in this order.

The first route forming portion 245 may also be configured such that the coin C is guided to the drawer 40 by the transport belt, in the same manner as the second route forming portion 246.

The second coin handling apparatus 23 may not have the function of depositing the coin C from the coin transport cassette 30 and the drawer 40.

As the feeding unit 35 of the coin transport cassette 30, a configuration in which an inclined rotary disk in the same manner as in the feeding unit 136 of the first coin handling apparatus 13 is rotated may also be used instead of the transport mechanism 351.

The first reception port 233A of the second coin handling apparatus 23 may not be provided at the position facing the discharge port 341 of the coin transport cassette 30 attached to the second cassette attachment unit 232, but a member for guiding the coin C discharged from the discharge port 341 to the first reception port 233A may be provided.

The second reception port 233B may also be provided at a position at which the second reception port 233B is not blocked by the coin transport cassette 30 attached to the second cassette attachment unit 232.

It may also be configured such that the exposure port 233C7 is not provided in the cover 233C, but the cover 233C is opened and the coin C is deposited through the second reception port 233B.

The tray 233D may not be provided in the cover 233C.

The disclosure of Japanese Patent Application No. 2020-050814, filed on Mar. 23, 2020, including the specification, drawings and abstract, is incorporated herein by reference in its entirety.

The present disclosure is applicable to a coin handling apparatus.

1. A coin handling apparatus comprising:
a drawer attachment unit to which a drawer for a register is attached;
a first cassette attachment unit to which a coin transport cassette is attached, the coin transport cassette comprising an opening and giving or receiving a coin to or from a specific apparatus via the opening, the opening being opened when the coin transport cassette is attached to the specific apparatus;
a storage unit that stores the coin, and feeds out the coin that has been stored; and
a first transport unit that transports the coin fed out of the storage unit to the drawer attached to the drawer attachment unit or the coin transport cassette attached to the first cassette attachment unit, wherein
the first cassette attachment unit is provided at a position different from a position of the drawer attachment unit and configured to allow the coin transport cassette to be attached to the first cassette attachment unit when the drawer is attached to the drawer attachment unit.

2. The coin handling apparatus according to claim 1, wherein
the drawer attachment unit is provided such that the drawer attached to the drawer attachment unit is located at a position downward from the storage unit, and
the first cassette attachment unit is configured such that the coin transport cassette attached to the first cassette attachment unit is located at a side of the drawer attached to the drawer attachment unit.

3. The coin handling apparatus according to claim 2, further comprising a depositing unit, wherein
the first cassette attachment unit is configured such that the coin transport cassette attached to the first cassette attachment unit is located on a side of the depositing unit relative to the drawer attached to the drawer attachment unit.

4. The coin handling apparatus according to claim 1, wherein the first transport unit comprises:
a first route forming portion forming a first route that guides the coin fed out of the storage unit to the drawer attached to the drawer attachment unit; and
a second route forming portion forming a second route that guides the coin fed out of the storage unit to the coin transport cassette attached to the first cassette attachment unit.

5. The coin handling apparatus according to claim 4, wherein
the storage unit comprises a plurality of storage boxes that stores the coin, and
the second route is provided so as to extend from below the plurality of storage boxes toward a side of the drawer attached to the drawer attachment unit.

6. The coin handling apparatus according to claim 5, wherein
the plurality of storage boxes is provided side by side in a horizontal direction, and
the second route is provided between the plurality of storage boxes.

7. The coin handling apparatus according to claim 4, wherein the first route forming portion comprises a chute that guides the coin fed out of the storage unit to the drawer attached to the drawer attachment unit.

8. The coin handling apparatus according to claim 4, wherein the second route forming portion comprises a transport belt that guides the coin fed out of the storage unit to the coin transport cassette attached to the first cassette attachment unit.

9. The coin handling apparatus according to claim 1, further comprising:
a second cassette attachment unit to which the coin transport cassette is attached;
a first reception port that receives the coin in the coin transport cassette attached to the second cassette attachment unit; and
a second transport unit that transports the coin to the storage unit, the coin having been received at the first reception port.

10. The coin handling apparatus according to claim 9, wherein the coin transport cassette comprises:
a cassette transport unit that transports the coin in a horizontal direction; and
an opening provided in a side surface of the coin transport cassette, the opening discharging the coin transported by the cassette transport unit.

11. The coin handling apparatus according to claim 10, wherein the first reception port is provided at a position facing the opening of the coin transport cassette attached to the second cassette attachment unit.

12. The coin handling apparatus according to claim 10, further comprising a second reception port that receives the coin, wherein
the second transport unit transports the coin to the storage unit, the coin having been received at the second reception port, and
the second cassette attachment unit is configured such that the second reception port is blocked by the coin transport cassette attached to the second cassette attachment unit.

13. The coin handling apparatus according to claim 12, further comprising a cover that covers the second cassette attachment unit, wherein
the cover comprises an exposure port that exposes the second reception port when the cover covers the second cassette attachment unit.

14. The coin handling apparatus according to claim 13, wherein the cover is provided with an exposure port covering portion that covers the exposure port.
